(19) United States
(12) Patent Application Publication
(10) Pub. No.: US 2015/0186477 A1
(43) Pub. Date: Jul. 2, 2015

(54) METHOD FOR INTER-GADGET DISPLAY COOPERATION AND INFORMATION PROCESSING APPARATUS

(71) Applicant: FUJITSU LIMITED, Kawasaki-shi (JP)

(72) Inventors: Fumihito NISHINO, Koto (JP); Nobuyuki IGATA, Kawasaki (JP)

(73) Assignee: FUJITSU LIMITED, Kawasaki-shi (JP)

(21) Appl. No.: 14/541,965

(22) Filed: Nov. 14, 2014

(30) Foreign Application Priority Data
Dec. 27, 2013 (JP) 2013-272064

(51) Int. Cl. G06F 17/30; G06F 3/0484

(52) U.S. Cl. CPC G06F 17/30554; G06F 3/0484

(57) ABSTRACT

A method for inter-gadget display cooperation acquires a first query processing result using a first gadget to which first query processing allocated and acquires a second query processing result using a second gadget to which second query processing allocated. Then, the method applies a common display mode to objects, which are included in the acquired first query processing result and the second query processing result and of which display modes are to be common between the first gadget and the second gadget, in a display corresponding to the first gadget and in a display corresponding to the second gadget.

### CROSS-REFERENCE TO RELATED APPLICATION(S)

This application is based upon and claims the benefit of priority of the prior Japanese Patent Application No. 2013-272064, filed on Dec. 27, 2013, the entire contents of which are incorporated herein by reference.

### FIELD

The embodiment discussed herein is related to a method for inter-gadget display cooperation and an information processing apparatus.

### BACKGROUND

In recent years, Linked Data is actively used as a technique of publishing data on the Web. Linked Data is a scheme of using the Web as global data space. While the current Web mainly functions as “a Web of documents for human readers”, Linked Data is compared with “a Web of data for machine processing.”

In screen generation on the Web, not only the contents of the screen are directly described in HTML and the like, but also the screen is generated so that data extracted from a database is displayed in the form of a graph. By using gadgets, pieces of data acquired from a plurality of databases associated by Linked Data can be displayed side by side in a single screen.

FIG. 14 illustrates examples of a screen displayed by using gadgets. In FIG. 14, the screen is prepared by using two gadgets. One gadget is to acquire from databases data on orders of an organization X, to calculate a ratio of order quantities per order destination on the basis of the acquired data, and to display the ratio in the form of a pie chart. The other gadget is to acquire data on orders of the whole organization relating to the organization X, to calculate a ratio of order quantities per order destination on the basis of the acquired data, and to display the ratio in the form of a pie chart.

Thus, pieces of data associated by Linked Data are displayed side by side, so that information analysis and the like can be supported. In this regard, development of a platform for publishing data based on Linked Data is being pursued.

Non-patent Literature 1: Igata, Nishino, Kume, Matsuzuka, “Linked Data wo mochiita joho togo/katsuyo gijutsu (Information Integration and Utilization Technology Using Linked Data)”, FUJITSU. 64, 5 (September 2013)

Non-patent Literature 2: “Information Workbench” retrieved from the Internet on Dec. 4, 2013 <URL:http://www.fluidops.com/information-workbench/>

### SUMMARY

According to an aspect of an embodiment, a method for inter-gadget display cooperation includes acquiring a first query processing result using a first gadget to which first query processing allocated; acquiring a second query processing result using a second gadget to which second query processing allocated; and applying a common display mode to objects, which are included in the acquired first query processing result and second query processing result and of which display modes are to be common between the first gadget and the second gadget, in a display corresponding to the first gadget and in a display corresponding to the second gadget.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration view illustrating an information processing apparatus according to an embodiment;

FIG. 2 illustrates one example of an adjustment part specification to be received by an adjustment part reception unit;

FIG. 3 illustrates one example of interactive change of gadgets;

FIG. 4 is an explanatory view illustrating color adjustment performed for two gadgets by an adjustment value determination unit;

FIG. 5 illustrates one example of color instruction to gadgets;

FIG. 6 illustrates one example of color orders instructed to gadgets by an adjustment value instruction unit when a graph plotting unit has default color orders;

FIG. 7 is a flow chart illustrating a flow of inter-gadget display cooperation processing performed by a cooperation unit;

FIG. 8 is a flow chart illustrating a flow of query execution processing performed by a query execution unit;

FIG. 9 is a flow chart illustrating a flow of adjustment value determination processing performed by the adjustment value determination unit;

FIG. 10 is a flow chart illustrating a flow of merge list addition processing;

FIG. 11 is a flow chart illustrating a flow of adjustment value determination processing performed by using hash codes;

FIG. 12 is a flow chart illustrating a flow of hash code color determination processing;

FIG. 13 is a functional block diagram illustrating the configuration of a computer that executes a program for inter-gadget display cooperation according to the embodiment; and

FIG. 14 illustrates an example of a screen displayed by using gadgets.

### DESCRIPTION OF EMBODIMENT(S)

Preferred embodiments of the present invention will be explained with reference to accompanying drawings. It is to be noted that these embodiments are not intended to limit the disclosed technology.

In the conventional display technology, each gadget independently operates, which makes it difficult to grasp correspondence relation between a plurality of gadgets in a display with use of these gadgets. The term “gadget” herein is used to refer to a component that extracts data from a database and processes and displays the extracted data.

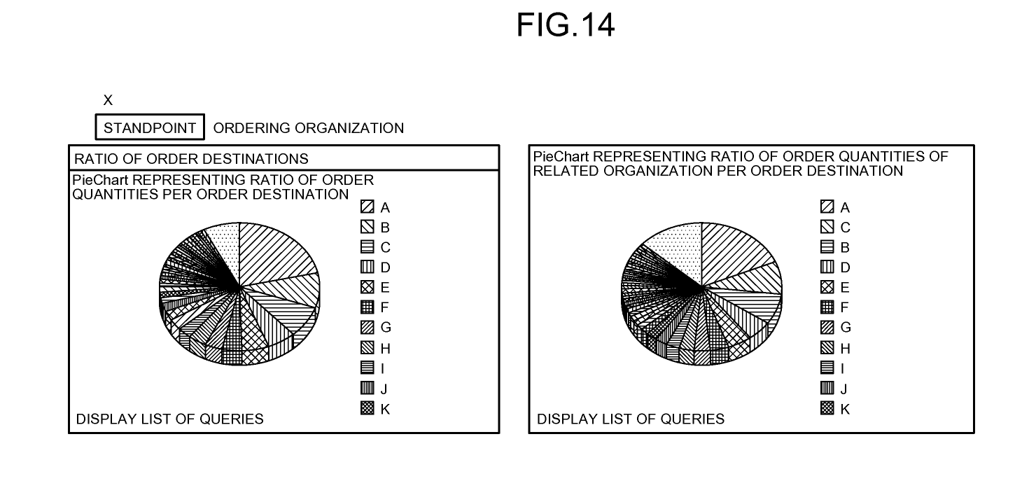

For example, in FIG. 14, two gadgets independently determine colors of the pie charts, so that different colors are allocated to the same organization. In FIG. 14, different colors are expressed by different patterns. In FIG. 14, the patterns, i.e., the colors, allocated to the organizations “B” and “C” in the left-side pie chart are different from those allocated in the right-side pie chart. However, it is desirable to allocate the same colors to the same organizations for information analysis.

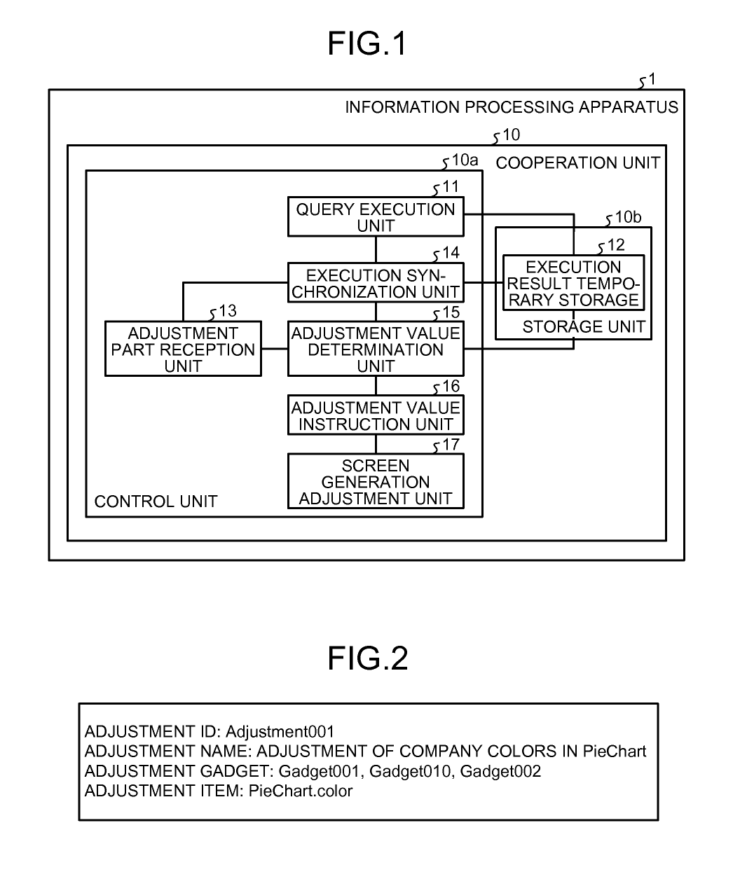

The configuration of an information processing apparatus according to an embodiment will be described. The information processing apparatus herein is a Web client for browsing a Web screen. FIG. 1 is a configuration view illustrating the information processing apparatus according to the embodiment. As illustrated in FIG. 1, an information processing apparatus 1 has a cooperation unit 10 that achieves display cooperation between gadgets when a Web screen is displayed on a display apparatus.

The cooperation unit 10 has a control unit 10a that performs control and a storage unit 10b that stores data for use in control and the like. The control unit 10a includes a query execution unit 11, an adjustment part reception unit 13, an execution synchronization unit 14, an adjustment value determination unit 15, an adjustment value instruction unit 16, and a screen generation adjustment unit 17. The storage unit 10b includes an execution result temporary storage 12.

The query execution unit 11 executes a query and stores a query execution result in the execution result temporary storage 12. Specifically, the query execution unit 11 executes a query so as to acquire data from a database and to generate screen data. The query execution unit 11 then stores the generated screen data in the execution result temporary storage 12.

More specifically, the query execution unit 11 receives a focus and a standpoint from a user, identifies a screen template corresponding to the standpoint, and executes gadgets included in the identified screen template to acquire data from databases.

The focus herein refers to an entity (substance) of interest, such as a company name, a person's name, a technical term, and an event. The standpoint signifies how the entity is observed. There are various standpoints for one entity. For example, in procurement, an orderer and an order receiver are standpoints. In product information, a manufacturer is a standpoint. The screen template is information which defines positions of graphs and maps on a screen and gadgets that display the graphs and the maps.

The query execution unit 11 retrieves from a database relating to the entity specified in the focus on the basis of the specified standpoint so as to acquire the data. A query for database retrieval is defined in association with a gadget. For example, if an organization name “X” is set as a focus, an “ordering organization” in procurement is set as a standpoint, and “retrieve order quantity per order company” is specified as a query, the query execution unit 11 retrieves from databases relating to the procurement by the organization name “X” from a standpoint of the “ordering organization,” and acquires data regarding the order quantity per ordering company. As for database retrieval, the query execution unit 11 makes a request to an information processing apparatus that stores databases via a network.

The execution result temporary storage 12 stores screen data generated by the query execution unit 11. The adjustment part reception unit 13 receives from a user an adjustment part specification that specifies items subjected to inter-gadget adjustment, and stores the specification in the storage unit in an extensible markup language (XML) format. The adjustment part reception unit 13 may use JavaScript (registered trademark) object notation (JSON) format instead of the XML format.

FIG. 2 illustrates one example of an adjustment part specification to be received by the adjustment part reception unit 13. As illustrated in FIG. 2, the adjustment part specification received by the adjustment part reception unit 13 includes an adjustment ID, an adjustment name, an adjustment gadget, and an adjustment item.

The adjustment ID is an identifier which identifies an adjustment part specification. The adjustment name is a name of the adjustment part specification. The adjustment ID is provided for machine processing, while the adjustment name is provided for users to determine the contents of adjustment. The adjustment gadget is a gadget subjected to adjustment. The adjustment item is an object subjected to adjustment, such as colors of respective segments of a pie chart and a value range of graph axes.

In the example illustrated in FIG. 2, the adjustment part specification identifier is “Adjustment001,” the adjustment part specification name is “adjustment of company colors in PieChart,” the gadget to be adjusted includes “Gadget001,” “Gadget010,” and “Gadget002,” and the object subjected to adjustment is “PieChart.color,” that is, the colors of the pie chart. Not only items of the same kind but also items of a plurality of kinds, such as “PieChart.color” and “BubbleChart.color” (colors of the bubble chart), may be included in the adjustment item.

The execution synchronization unit 14 synchronizes query executions. Specifically, the execution synchronization unit 14 checks whether or not execution results of a plurality of gadgets specified in the adjustment part specification have been obtained, and synchronizes executions of the plurality of gadgets.

More specifically, the execution synchronization unit 14 checks by confirming whether or not the execution results have been stored in the execution result temporary storage 12. The execution synchronization unit 14 may check whether or not execution results of the gadgets have been obtained by receiving from each of the gadgets a notification notifying whether or not query execution has been completed. In any case, the execution synchronization unit 14 checks, with respect to target adjustment, whether or not retrievals by the gadgets which are subjected to adjustment have been completed, and waits for completion of all the retrievals subjected to adjustment.

A user may interactively change or add gadgets, so that some gadgets to be adjusted may be inactive. An inactive state is provided in addition to an execution completion state and an executing state, so that the execution synchronization unit 14 determines completion of executions only for the gadgets that are not in the inactive state, and performs synchronization thereof.

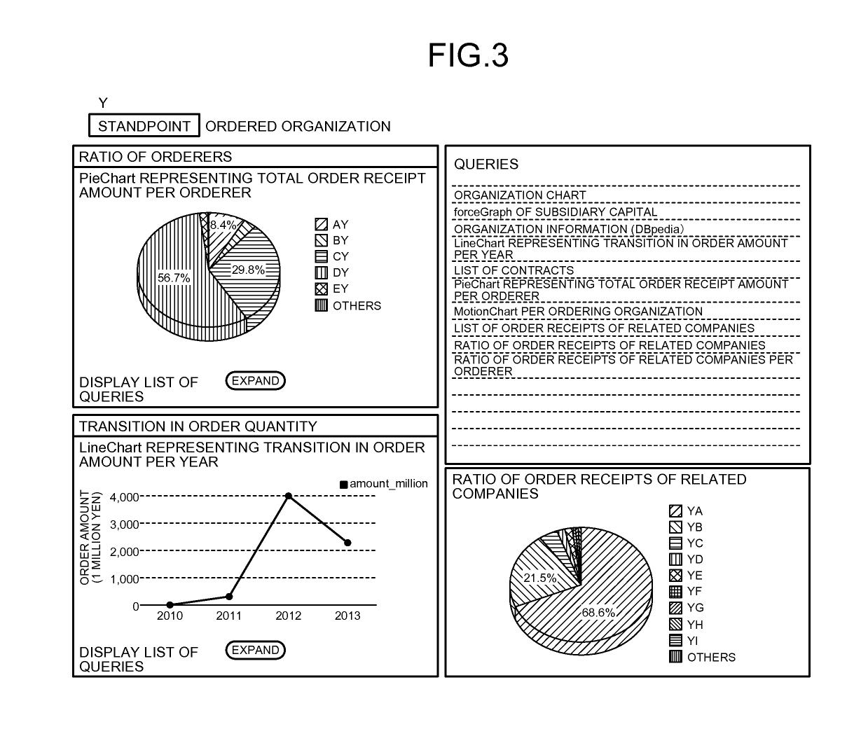

FIG. 3 illustrates one example of interactive change of gadgets. FIG. 3 illustrates displays by gadgets, such as “ratio of orderers,” “transition in order quantity,” and “ratio of order receipts of related companies,” as well as a list of queries corresponding to the gadgets. In the right upper column of FIG. 3, “organization chart,” “forceGraph of subsidiary capital,” . . . , “ratio of order receipts of related companies per orderer” are identifiers which identify queries. The user can interactively change active and inactive statuses of the gadgets by selecting queries.

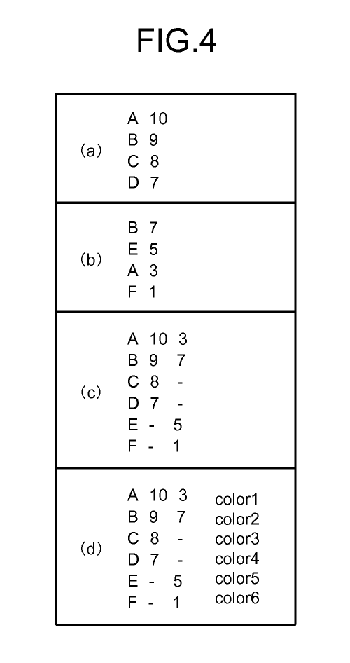

The adjustment value determination unit 15 determines colors to be adjusted and scales (axis value ranges) to be adjusted, on the basis of the adjustment part specification received by the adjustment part reception unit 13. The adjustment value determination unit 15 may adjust and determine the reduced scales of maps. FIG. 4 is an explanatory view illustrating color adjustment performed for two gadgets by the adjustment value determination unit 15.

FIG. 4(a) illustrates a query result of a first gadget. In FIG. 4(a), the value of item A is 10, the value of item B is 9, the value of item C is 8, and the value of item D is 7. FIG. 4(b) illustrates a query result of a second gadget. In FIG. 4(b), the value of the item B is 7, the value of item E is 5, the value of the item A is 3, and the value of item F is 1.

The adjustment value determination unit 15 adjusts colors of the items by collating the same items in two gadgets with each other. FIG. 4(c) illustrates a result of merging the query results of two gadgets. As illustrated in FIG. 4(c), the adjustment value determination unit 15 collates the same items in two gadgets with each other by merging the query result of the first gadget with the query result of the second gadget.

The adjustment value determination unit 15 then allocates colors to the merged items in an appearance order as illustrated in FIG. 4(d). In FIG. 4(d), “color 1” is allocated to the item A, “color 2” is allocated to the item B, “color 3” is allocated to the item C, “color 4” is allocated to the item D, “color 5” is allocated to the item E, and “color 6” is allocated to the item F.

The adjustment value determination unit 15 may perform color adjustment by using hash codes. For example, the adjustment value determination unit 15 allocates colors to the query result of the first gadget as follows:

A 10 color.hash(A)
B 9 color.hash(B)
Here, color.hash(A) represents a color corresponding to hash code A.

The adjustment value determination unit 15 also allocates colors to the second gadget as follows:

B 7 color.hash(B)
E 5 color.hash(E)

For example, when values of RGB are expressed by 00 to FF in hexadecimals, color values are determined to be in the range of 000000 to FFFFFF in hexadecimals. Accordingly, the hash values are set to be within this range. To avoid white and black colors, conditions may be added to the color range. Moreover, the number of colors (for example, 32 colors) to be used may be determined in advance, and color allocation may be performed in this range.

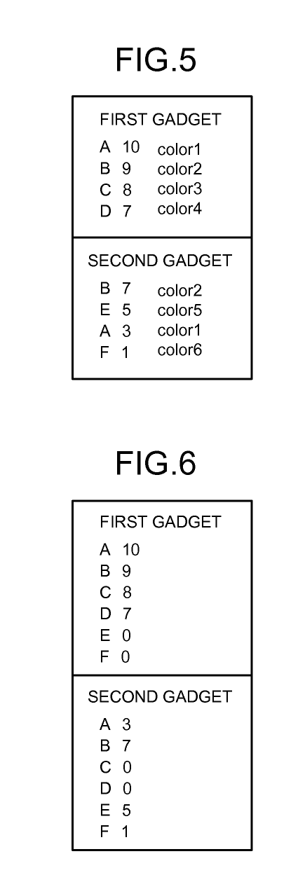

The adjustment value instruction unit 16 instructs to the gadgets the adjusted colors, the adjusted scales, the adjusted reduced scales of maps, and the like, which have been adjusted by the adjustment value determination unit 15. For example, when the colors have been adjusted by the adjustment value determination unit 15, the adjustment value instruction unit 16 instructs determined colors to the gadgets, so that the colors are instructed to the graph plotting unit which plots graphs. FIG. 5 illustrates one example of color instruction to gadgets. FIG. 5 illustrates colors instructed to the gadgets by the adjustment value instruction unit 16 when colors are allocated as illustrated in FIG. 4.

As illustrated in FIG. 5, the adjustment value instruction unit 16 instructs, to the first gadget, “color 1” as the color of the item A, “color 2” as the color of the item B, “color 3” as the color of the item C, and “color 4” as the color of the item D. The adjustment value instruction unit 16 also instructs, to the second gadget, “color 2” as the color of the item B, “color 5” as the color of the item E, “color 1” as the color of the item A, and “color 6” as the color of the item F.

When the graph plotting unit has a default color order, the adjustment value instruction unit 16 instructs an order to the gadgets. The adjustment value instruction unit 16 sets an order of appearance of the items to be identical between the plurality of gadgets, and embeds an undefined value for items without a value. The adjustment value instruction unit 16 uses 0 as an undefined value, for example.

FIG. 6 illustrates one example of color orders instructed to gadgets by the adjustment value instruction unit 16 when the graph plotting unit has a default color order. As illustrated in FIG. 6, the adjustment value instruction unit 16 sets an order of appearance of the items A to F to be identical between two gadgets. The adjustment value instruction unit 16 embeds an undefined value for the item E and the item F in the case of the first gadget, and embeds an undefined value for the item C and the item D in the case of the second gadget.

When colors are determined by using hash codes, the adjustment value instruction unit 16 instructs the colors determined by the hash codes to the gadgets.

The screen generation adjustment unit 17 adjusts screen data, such as graph representation and a display of maps, on the basis of the instruction by the adjustment value instruction unit 16.

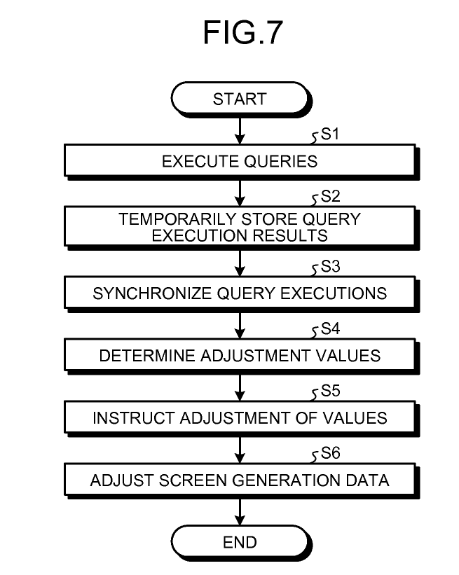

A description will now be given of a flow of inter-gadget display cooperation processing performed by the cooperation unit 10. FIG. 7 is a flow chart illustrating a flow of inter-gadget display cooperation processing performed by the cooperation unit 10. As illustrated in FIG. 7, the query execution unit 11 executes queries (step S1), and temporarily stores query execution results in the execution result temporary storage 12 (step S2).

Once the execution synchronization unit 14 synchronizes query executions (step S3) and achieves synchronization, the adjustment value determination unit 15 determines adjustment values on the basis of the adjustment part specification received by the adjustment part reception unit 13 (step S4).

Then, the adjustment value instruction unit 16 instructs adjustment of the values to the plurality of gadgets which are subjected to adjustment (step S5), and the screen generation adjustment unit 17 adjusts screen generation data on the basis of the instruction by the adjustment value instruction unit 16 (step S6).

Thus, the adjustment value instruction unit 16 instructs adjustment of the values to the plurality of gadgets on the basis of the values determined by the adjustment value determination unit 15. As a result, the cooperation unit 10 can achieve inter-gadget display cooperation.

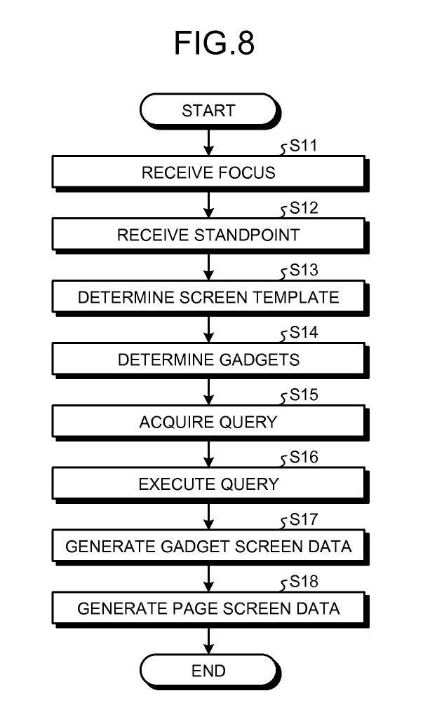

A description will now be given of a flow of query execution processing performed by the query execution unit 11. FIG. 8 is a flow chart illustrating the flow of query execution processing performed by the query execution unit 11. As illustrated in FIG. 8, the query execution unit 11 receives a focus and a standpoint from a user (steps S11 to S12).

The query execution unit 11 determines a screen template associated with the standpoint (step S13), and determines a plurality of gadgets included in the screen template (step S14).

The query execution unit 11 then acquires a query, i.e., a query for one of the gadgets (step S15), and executes the acquired query (step S16) to generate gadget screen data (step S17). The query execution unit 11 repeats the processing of steps S15 to S17 by the number of the gadgets. The query execution unit 11 then generates page screen data (step S18), and stores the data in the execution result temporary storage 12.

Thus, the query execution unit 11 can generate the screen data about a screen displayed on the display apparatus by executing the plurality of gadgets included in the screen template associated with the standpoint.

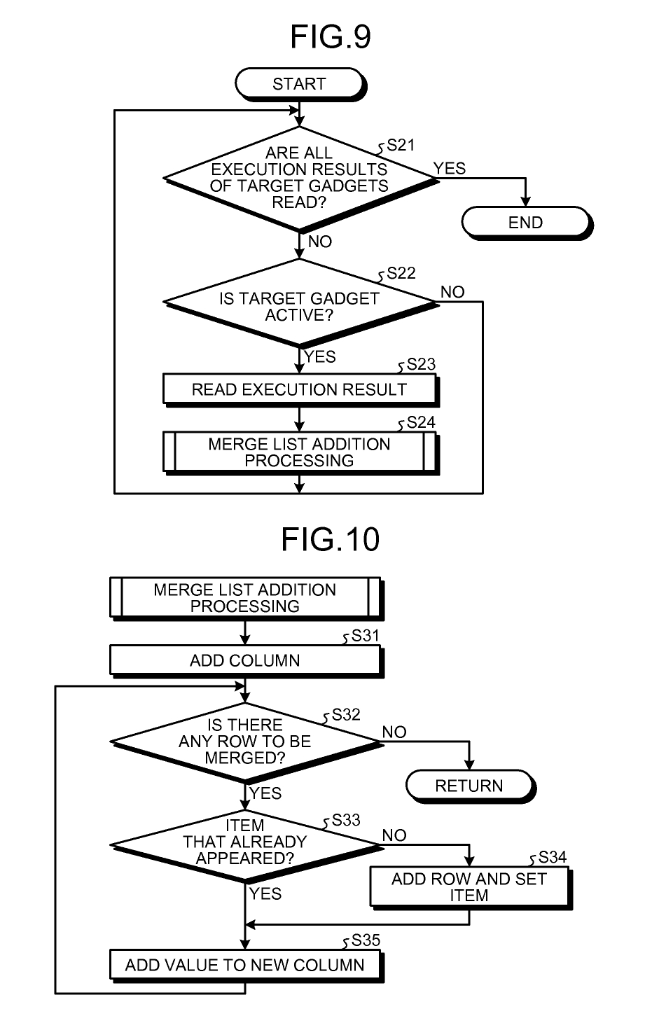

A description will now be given of a flow of adjustment value determination processing performed by the adjustment value determination unit 15. FIG. 9 is a flow chart illustrating the flow of adjustment value determination processing performed by the adjustment value determination unit 15. FIG. 9 illustrates a flow in the case of adjusting the colors of items in a pie chart.

As illustrated in FIG. 9, the adjustment value determination unit 15 determines whether or not all the execution results of the gadgets subjected to adjustment have been read (step S21). If all the execution results have been read, the processing is ended.

If any of the execution results of the gadgets subjected to adjustment has not yet been read, the adjustment value determination unit 15 determines whether or not a target gadget is active (step S22). When the target gadget is not active, display by the gadget is not performed, and so the processing returns to step S21.

Contrary to this, if the target gadget is active, the adjustment value determination unit 15 reads the execution result of the gadget (step S23), and executes merge list addition processing configured to add the read execution result to a merge list (step S24). Then, the adjustment value determination unit 15 returns to step S21.

FIG. 10 is a flow chart illustrating a flow of merge list addition processing. As illustrated in FIG. 10, in the merge list addition processing, the adjustment value determination unit 15 adds a column to the merge list (step S31), and determines whether or not there is still any row to be merged (step S32).

When there is no row to be merged, the adjustment value determination unit 15 ends the processing, whereas when there is still any row to be merged, the adjustment value determination unit 15 determines whether or not an item to be merged has already appeared (step S33).

When the item to be merged has not yet appeared, the adjustment value determination unit 15 adds a row and sets the item (step S34). The adjustment value determination unit 15 then adds a value to the new column (step S35), and returns to step S32.

Thus, the adjustment value determination unit 15 can collate the same items with one another among the gadgets by merging the execution results of the gadgets.

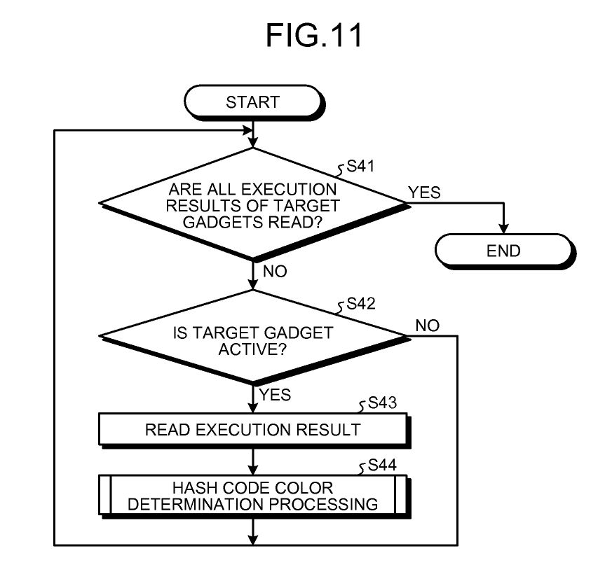

A description will now be given of a flow of adjustment value determination processing performed by using hash codes. FIG. 11 is a flow chart illustrating the flow of adjustment value determination processing performed by using hash codes. FIG. 11 illustrates a flow in the case of adjusting the colors of the items in a pie chart.

As illustrated in FIG. 11, the adjustment value determination unit 15 determines whether or not all the execution results of the gadgets subjected to adjustment have been read (step S41). If all the execution results have been read, the processing is ended.

If any of the execution results of the gadgets subjected to adjustment has not yet been read, the adjustment value determination unit 15 determines whether or not a target gadget is active (step S42). If the target gadget is not active, a display by the gadget is not performed, and the processing returns to step S41.

Contrary to this, if the target gadget is active, the adjustment value determination unit 15 reads the execution result of the gadget (step S43), and executes hash code color determination processing configured to determine the colors of the items included in the read execution result by using hash codes (step S44). Then, the adjustment value determination unit 15 returns to step S41.

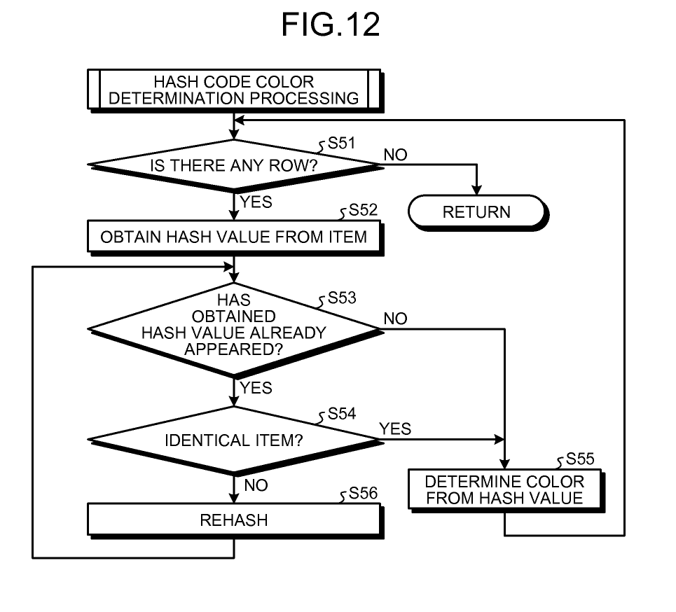

FIG. 12 is a flow chart illustrating a flow of hash code color determination processing. As illustrated in FIG. 12, in the hash code color determination processing, the adjustment value determination unit 15 determines whether or not there is still any row in the read execution result (step S51).

When there is no row in the read execution result, the adjustment value determination unit 15 ends the processing, whereas when there is still any row in the read execution result, a hash value is obtained from the item (step S52).

The adjustment value determination unit 15 determines whether or not the obtained hash value is a hash value that has already appeared (step S53). If it is the hash value that has already appeared, then it is determined whether or not the item is identical (step S54). If the item is not identical, it means that the hash value is overlapped, and therefore the adjustment value determination unit 15 performs rehashing (step S56), and the processing returns to step S53.

When the item is identical, the adjustment value determination unit 15 determines a color from the hash value (step S55), and the processing returns to step S51. When the hash value is not a hash value that has already appeared, the adjustment value determination unit 15 determines a color from the hash value (step S55), and the processing returns to step S51.

Thus, the adjustment value determination unit 15 obtains hash values from the items and determines colors from the obtained hash values, so that the colors of the items can be unified among the gadgets.

As mentioned above, in the embodiment, the query execution unit 11 executes the plurality of gadgets, which form a screen, to retrieve from databases, and stores query results in the execution result temporary storage 12. The adjustment value determination unit 15 then reads out the query results from the execution result temporary storage 12, and adjusts the colors of items, the scales of graphs, the reduced scales of maps, and the like, which are subjected to adjustment among gadgets. Then, the adjustment value instruction unit 16 instructs adjustment values to the gadgets, and the screen generation adjustment unit 17 adjusts the screen including graphs, maps and the like, on the basis of the adjustment values. Thus, the cooperation unit 10 can achieve display cooperation among gadgets.

Although the cooperation unit 10 has been described in the embodiment, a program for inter-gadget display cooperation having the same functions may be obtained by implementing the configuration of the cooperation unit 10 in the form of software. Accordingly, a computer that executes the program for inter-gadget display cooperation will be described.

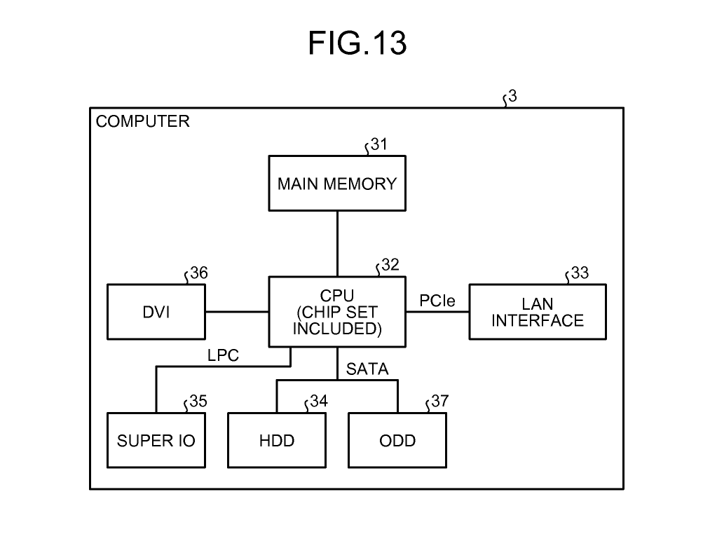

FIG. 13 is a functional block diagram illustrating the configuration of a computer 3 that executes the program for inter-gadget display cooperation according to the embodiment. As illustrated in FIG. 13, the computer 3 has a main memory 31, a central processing unit (CPU) 32, a local area network (LAN) interface 33, and a hard disk drive (HDD) 34. The computer 3 also has a super input output (IO) 35, a digital visual interface (DVI) 36, and an optical disk drive (ODD) 37.

The main memory 31 is a memory that stores programs, middle results of executing the programs, and the like. The CPU 32 is a central processing unit that reads out a program from the main memory 31 and executes the program. The CPU 32 includes a chip set having a memory controller.

The LAN interface 33 is configured to connect the computer 3 to other computers via the LAN. The HDD 34 is a disk unit that stores programs and data. The super IO 35 is an interface for connecting input devices, such as a mouse and a keyboard. The DVI 36 is an interface that connects a liquid crystal display. The ODD 37 is a device that performs read and write access to DVDs. A screen where inter-gadget display cooperation was achieved is displayed on the liquid crystal display.

The LAN interface 33 is connected to the CPU 32 through a PCI express (PCIe), while the HDD 34 and the ODD 37 are connected to the CPU 32 through a serial advanced technology attachment (SATA). The Super IO 35 is connected to the CPU 32 through a low pin count (LPC).

The program for inter-gadget display cooperation executed in the computer 3 is stored in a DVD and is read out from the DVD by the ODD 37, before being installed in the computer 3. Or alternatively, the program for inter-gadget display cooperation is stored in databases and the like of other computer systems connected via the LAN interface 33 and is read out from these databases, before being installed in the computer 3. The installed program for inter-gadget display cooperation is stored in the HDD 34 and is read to the main memory 31 so as to be executed by the CPU 32.

Although the case where the gadgets display graphs and the like on the screen has been described in the embodiment, the present invention is not limited thereto. The present invention is similarly applicable to the case of achieving cooperation of other outputs, such as the gadgets outputting data to paper, i.e. achieving cooperation of outputs including display and printing among a plurality of gadgets.

Although the case of achieving display cooperation among a plurality of gadgets on one screen has been described in the embodiment, the present invention is not limited thereto. The present invention is similarly applicable to the case of achieving display cooperation among a plurality of gadgets on different screens.

According to one embodiment, it becomes possible to easily grasp correspondence relation between a plurality of gadgets in a display using these gadgets.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method for inter-gadget display cooperation, the method comprising:
acquiring a first query processing result using a first gadget to which first query processing allocated;
acquiring a second query processing result using a second gadget to which second query processing allocated; and
applying a common display mode to objects, which are included in the acquired first query processing result and second query processing result and of which display modes are to be common between the first gadget and the second gadget, in a display corresponding to the first gadget and in a display corresponding to the second gadget.

2. The method for inter-gadget display cooperation according to claim 1, wherein a display area corresponding to the first gadget and a display area corresponding to the second gadget are included in an identical display screen.

3. The method for inter-gadget display cooperation according to claim 1, wherein a display area corresponding to the first gadget and a display area corresponding to the second gadget are arranged side by side in a row direction or in a column direction.

4. The method for inter-gadget display cooperation according to claim 1, wherein
the objects of which display modes are to be common are display elements of graphs, and
the common display mode is display color of the display elements.

5. The method for inter-gadget display cooperation according to claim 1, wherein
the objects of which display modes are to be common are display elements of graphs, and
the common display mode is scale of the graph.

6. A non-transitory computer readable storage medium that stores a program for inter-gadget display cooperation that allows a computer to execute a process comprising:
acquiring a first query processing result using a first gadget to which first query processing allocated;
acquiring a second query processing result using a second gadget to which second query processing allocated; and
applying a common display mode to objects, which are included in the acquired first query processing result and second query processing result and of which display modes are to be common between the first gadget and the second gadget, in a display corresponding to the first gadget and in a display corresponding to the second gadget.

7. An information processing apparatus including a processor that performs a process comprising:
acquiring a first query processing result using a first gadget to which first query processing allocated;
acquiring a second query processing result using a second gadget to which second query processing allocated; and
applying a common display mode to objects, which are included in the acquired first query processing result and second query processing result and of which display modes are to be common between the first gadget and the second gadget, in a display corresponding to the first gadget and in a display corresponding to the second gadget.
